(19) United States
(12) Patent Application Publication
(10) Pub. No.: US 2002/0066378 A1
(43) Pub. Date: Jun. 6, 2002

(54) Process and apparatus of transferring a dye sublimation print to a polymer coated article

(76) Inventors: Robert E. Almblad, Mundelein, IL (US); John Blin, Arlington Heights, IL (US); Jay M. Almblad, Mundelein, IL (US)

Correspondence Address: MICHAEL R. McKENNA, Ste. 3800, 500 W. Madison Street, Chicago, IL, 60661-2511, US

(21) Appl. No.: 09/728,770

(22) Filed: Dec. 1, 2000

Related U.S. Application Data
(60) Provisional application No. 60/168,334, filed on Dec. 1, 1999.

(51) Int. Cl. B41D 7/00; B41F 17/00

(52) U.S. Cl. 101/35; 101/33

(57) ABSTRACT

An apparatus and method of semi-automatically transferring a dye sublimation print to a polymer coated article. Process steps include efficiently applying a combination heater and pressure applicator to a dye sublimation print and the outer surface of the polymer coated article for a preselected period of time and automatically withdraws the combination heater and pressure applicator, to avoid overheating, upon reaching the preselected period of time.

### BACKGROUND OF THE INVENTION

This invention relates to a process and apparatus of semi-automatically transferring a dye sublimation print to a polymer coated article. The apparatus efficiently applies a combination heater and pressure applicator to a dye sublimation print and the outer surface of the polymer coated article for a preselected period of time and automatically withdraws the combination heater and pressure applicator, to avoid overheating, upon reaching the preselected period of time.

Sublimation as a process is really quite simple. It is the method of applying an image to cloth, metals, plastics and ceramics using three primary ingredients: sublimation ink, heat and pressure. Sublimation ink is unique in its ability to convert from a solid to a gas without going through a liquid form. (Just like dry ice.) The conversion is initiated by heat and controlled with pressure.

There is no single color, imprinting method that will print text (especially with names) and single color graphics, on metal plates and many textiles, faster or more economically than dye sublimation toner cartridges, in an ordinary desktop laser printer, using plan copier paper to produce a dye sublimation print. Added to this is the fact that the graphic “look” of sublimated products are widely accepted and bought, all across the United States. Add low start-up cost to the above and it is easy to understand why this process is a great addition to an existing business and even a great start-up venture by itself.

Sublimation allows a dozen items to be imprinted much cheaper than screening or thousands of items to be imprinted much, much faster than engraving. Unlike the old days of hand lettering and engraving, the power of the computer, and a sublimation cartridge, can turn anyone into sought-after skilled artist.

When sublimation toner is put next to a polymer coated substance and both are heated, in a heat press, a wonderful transformation takes place. At about 250° (F.) the solid toner starts turning into a gas and at about 320 degrees the polymer “pores” start opening up and the gas starts going into it. The 350-450 degree transfer temperature is recommended. While the transfer takes place in a very short time, additional time is required to allow for good saturation and penetration. The process is complete within 3 minutes or less. Almost as soon as the heat press is opened, the temperature drops, the gas goes to a solid, the polymer molecules close up (this is why sublimation print doesn't wash off).

The method of transferring a dye sublimation photo print to a polymer coated mug by driving down a heated “C” shaped clamp requires about 200 lbs of pressure. This motion is manually initiated by the operator after a print is placed between the mug and the “C” clamp, and then the machine automatically drives down the “C” clamp and then releases the “C” clamp after about 3 minutes. This prevent the operator from over or under cooking the photo.

### ADVANTAGES OF THIS INVENTION

Because of the timed automatic features of the apparatus and method of transferring a dye sublimation print to a polymer coated article, image transfer can be accomplished without overheating or burning off the dyes and receiving media.

Still other advantages will be apparent from the disclosure that follows.

### SUMMARY OF THE INVENTION

The invention relates to an apparatus and method of transferring a dye sublimation print to a polymer coated article. Process steps include disposing a polymer coated article with an outer surface in a stationary article holder, disposing a dye sublimation print between the outer surface of the polymer coated article and a combination heater and pressure applicator where the combination heater and pressure applicator having a heat transfer temperature at a predetermined amount, activating a motor to dispose the combination heater and pressure applicator in a pressured relationship with the dye sublimation print and the outer surface of the polymer coated article for a preselected period of time, and activating the motor to withdraw the combination heater and pressure applicator to a spaced distance from the dye sublimation print and the outer surface of the polymer coated article, to avoid overheating, upon reaching the preselected period of time.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

Preferred embodiments of the invention are described hereinafter with reference to the accompanying drawing wherein:

FIG. 1 is an exploded view of the semi-automatic apparatus for transferring a dye sublimation print to a polymer coated article showing the components removed from a frame;

FIG. 2 is a perspective view of the semi automatic apparatus with the components disposed within the frame;

FIG. 3 is a schematic of the control circuit of the instant invention; and

FIG. 4 is a schematic of the power circuit of the semi-automatic apparatus for transferring a dye sublimation print to a polymer coated article.

### DETAILED DESCRIPTION OF THE INVENTION

Without departing from the generality of the invention disclosed herein and without limiting the scope of the invention, the discussion that follows, will refer to the invention as depicted in the drawing.

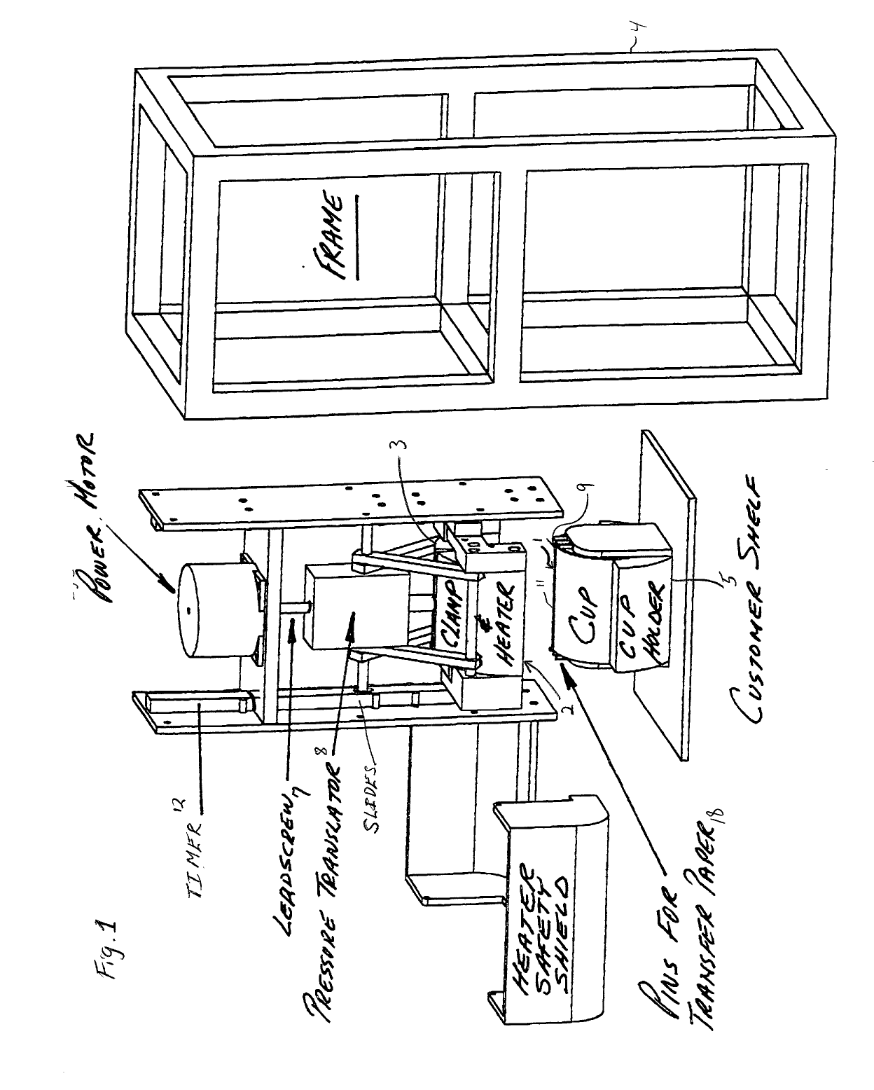

The preferred embodiments of the apparatus depicted in the drawing comprise a semi-automatic apparatus for transferring a dye sublimation print to a polymer coated article comprises a frame 4; an article holder 5 disposed in a fixed position on the frame; a combination heater and pressure applicator 2; a motor 6 with a motive shaft 7 that is disposed in a fixed position on the frame; a timer 12; a control circuit 14 in operative association with the timer and the motor; a power circuit 16 in operative association with the motor, the heater, and the timer; and a pressure translator 8, in operative association with the motive shaft and the combination heater and pressure applicator, for receiving a motive force from the motor and translating the motive force to the combination heater and pressure applicator. The pressure translator is slidably disposed relative to the frame, and the combination heater and pressure applicator is movable between a first position (shown in FIG. 1) at a spaced distance from the article holder and a second position in which the combination heater and pressure applicator is in a predetermined pressured contact with a polymer coated article disposed in the article holder.

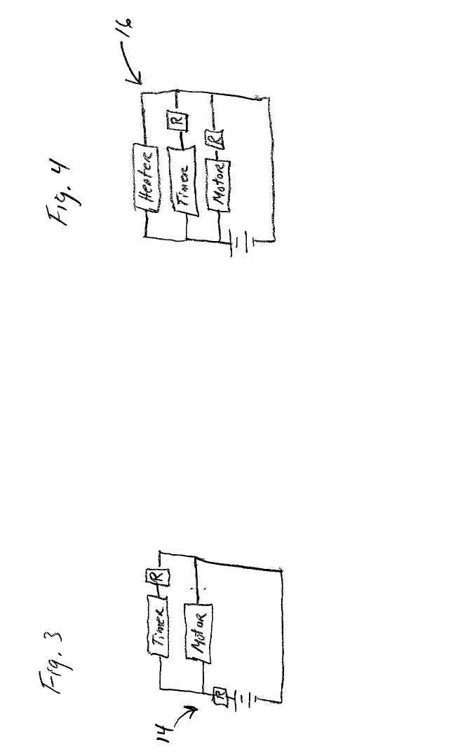

FIGS. 3 and 4 show the control and power circuits, respectively.

In the operation of this apparatus, the polymer coated article 9 can be disposed in the article holder, the dye sublimation print can be disposed between the polymer coated article and the combination heater and pressure applicator disposed in the first position, the power circuit can be energized to bring about a predetermined heater temperature, the control circuit can initiated to activate the timer and cause the motor to move the combination heater and pressure applicator to the second position for a predetermined period of time to transfer the dye of the dye sublimation print to the polymer coating of the article independent of overheating.

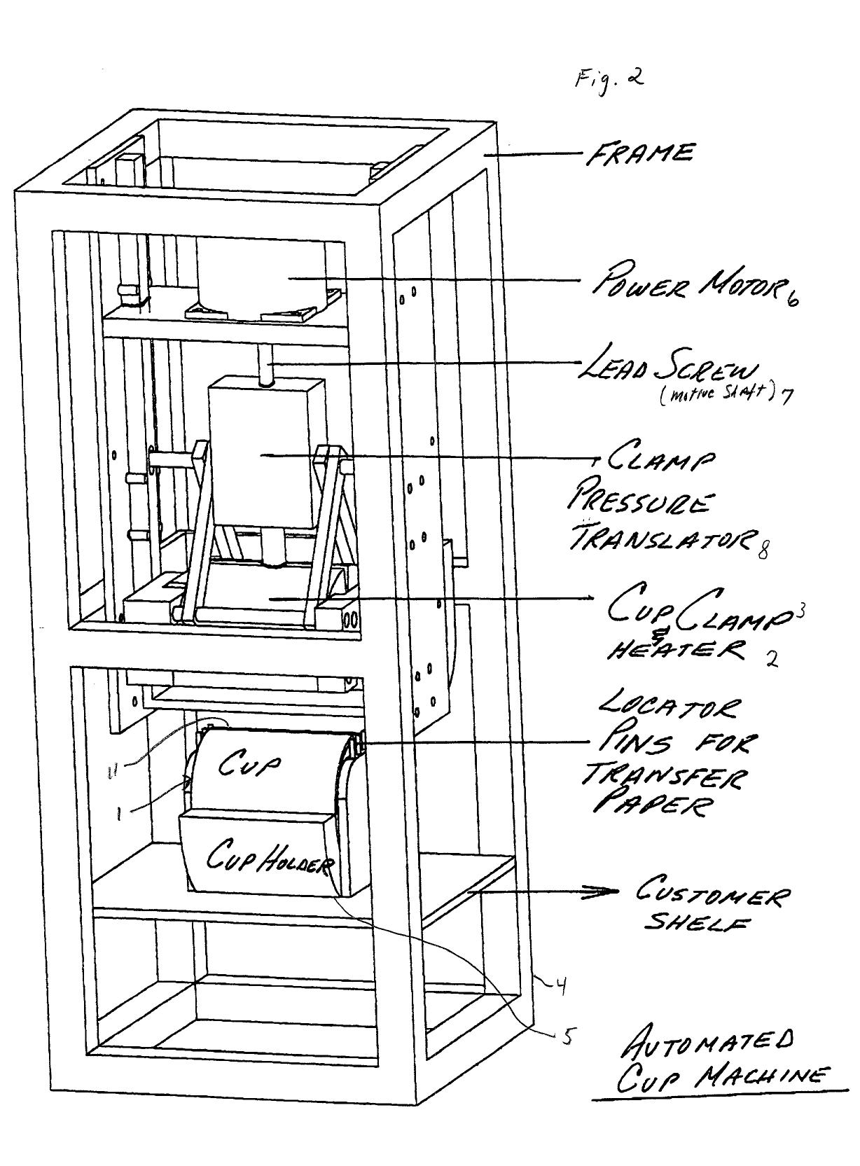

As shown in FIGS. 1 and 2 of the drawing, the semi-automatic apparatus for transferring a dye sublimation print to a polymer coated article, the article can be a cup 1 with an cylindrical outer surface 11 on which the transfer occurs and the combination heater and pressure applicator 2 comprises a split and hinged “C” shaped clamp 3.

FIGS. 1 and 2 show a preferred embodiment of the invention. In the semiautomatic apparatus for transferring a dye sublimation print to a polymer coated article of the present invention, the components are arranged vertically within a frame to enhance space utilization. The article holder is disposed in line with and below the combination heater and pressure, which is in line with and below the pressure translator, the pressure translator is in line with and below motor, and the frame is elongated vertically and contains said components.

In another preferred embodiment of the semi-automatic apparatus for transferring a dye sublimation print to a polymer coated article, the motive shaft 7 is threaded and the pressure translator 8 has a threaded recess to receive the threaded shaft.

Preferably, the article holder 5 has pins 18 for guiding the placement of the dye sublimation print.

The invention includes a process of transferring a dye sublimation print to a polymer coated article comprising the steps of:

a. disposing a polymer coated article with an outer surface in a stationary article holder;

b. disposing a dye sublimation print between the outer surface of the polymer coated article and a combination heater and pressure applicator,

said combination heater and pressure applicator having a heat transfer temperature at a predetermined amount;

c. activating a motor to dispose the combination heater and pressure applicator in a pressured relationship with the dye sublimation print and the outer surface of the polymer coated article for a preselected period of time; and

d. activating the motor to withdraw the combination heater and pressure applicator to a spaced distance from the dye sublimation print and the outer surface of the polymer coated article, to avoid overheating, upon reaching the preselected period of time.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is base, may readily be utilized as a basis for the designing of other structures, methods and systems for carrying out the several purposes of the present invention. It is important, therefore, that the claims be regarded as including such equivalent constructions insofar as they do not depart from the spirit and scop of the present invention.

My invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A semi-automatic apparatus for transferring a dye sublimation print to a polymer coated article comprising:
a. a frame;
b. an article holder disposed in a fixed position on the frame;
c. a combination heater and pressure applicator;
d. a motor with a motive shaft,
said motor being disposed in a fixed position on the frame;
e. a timer;
f. a control circuit in operative association with the timer and the motor;
g. a power circuit in operative association with the motor, the heater, and the timer;
h. a pressure translator, in operative association with the motive shaft and the combination heater and pressure applicator, for receiving a motive force from the motor and translating the motive force to the combination heater and pressure applicator,
said pressure translator being slidably disposed relative to the frame, and
said combination heater and pressure applicator being movable between a first position at a spaced distance from the article holder and a second position in which the combination heater and pressure applicator is in a predetermined pressured contact with a polymer coated article disposed in the article holder, whereby:
the polymer coated article can be disposed in the article holder, the dye sublimation print can be disposed between the polymer coated article and the combination heater and pressure applicator disposed in the first position,
the power circuit can be energized to bring about a predetermined heater temperature,
the control circuit can initiated to activate the timer and cause the motor to move the combination heater and pressure applicator to the second position for a predetermined period of time to transfer the dye of the dye sublimation print to the polymer coating of the article independent of overheating.

2. The semi-automatic apparatus for transferring a dye sublimation print to a polymer coated article of claim 1, in which the article is a cup with an cylindrical outer surface on which the transfer occurs and the combination heater and pressure applicator comprises a split and hinged “C” shaped clamp.

3. The semi-automatic apparatus for transferring a dye sublimation print to a polymer coated article of claim 1, in which the article holder is disposed in line with and below the combination heater and pressure, which is in line with and below the pressure translator,
wherein the pressure translator is in line with and below motor, and
wherein the frame is elongated vertically and contains said components.

4. The semi-automatic apparatus for transferring a dye sublimation print to a polymer coated article of claim 1, in which the motive shaft is threaded and the pressure translator has a threaded recess to receive the threaded shaft.

5. The semi-automatic apparatus for transferring a dye sublimation print to a polymer coated article of claim 1, in which the article holder has pins for guiding the placement of the dye sublimation print.

6. A process of transferring a dye sublimation print to a polymer coated article comprising the steps of:
a. disposing a polymer coated article with an outer surface in a stationary article holder;
b. disposing a dye sublimation print between the outer surface of the polymer coated article and a combination heater and pressure applicator,
said combination heater and pressure applicator having a heat transfer temperature at a predetermined amount;
c. activating a motor to dispose the combination heater and pressure applicator in a pressured relationship with the dye sublimation print and the outer surface of the polymer coated article for a preselected period of time; and
d. activating the motor to withdraw the combination heater and pressure applicator to a spaced distance from the dye sublimation print and the outer surface of the polymer coated article, to avoid overheating, upon reaching the preselected period of time.
